(19) United States
(12) Patent Application Publication
(10) Pub. No.: US 2007/0257016 A1
(43) Pub. Date: Nov. 8, 2007

(54) Heated Device for Dispensing a Volatile Active

(75) Inventors: Zhihong Jin, Cottage Grove, WI (US); William C. Bushong, Madison, WI (US); Gregory J. Davidson, Oregon, WI (US); Joseph L. Passaniti, Madison, WI (US); Karthik Ramaswami, Middleton, WI (US); Viet H. Vu, Verona, WI (US)

Correspondence Address: Christopher M. Goff (27840);ARMSTRONG TEASDALE LLP, ONE METROPOLITAN SQUARE, SUITE 2600, ST. LOUIS, MO, 63102, US

(73) Assignee: ROVCAL, INC., Madison, WI (US)

(21) Appl. No.: 11/742,992

(22) Filed: May 1, 2007

Related U.S. Application Data
(60) Provisional application No. 60/796,658, filed on May 2, 2006.

(51) Int. Cl. H05B 3/00; A01N 25/00

(52) U.S. Cl. 219/201; 424/405

(57) ABSTRACT

The present disclosure generally relates to a device for dispensing a volatile active material that may be direct current (DC) (batteries, fuel cells, solar cells, and the like) powered or chemically powered. More particularly, the present disclosure relates to a battery operated insect repellant device that is easily portable and is capable of providing a sufficient vaporous stream of a volatile insecticide and/or other active agent, to protect a user. The battery operated insect repellant device is configured to operate at high efficiency such that a high percentage of battery energy input into the device is converted to heat used to volatilize the insecticide or other active agent.

### REFERENCE TO RELATED APPLICATION

This application claims the benefit of U.S. Provisional Application Ser. No. 60/796,658 which was filed on May 2, 2006. The entire content of the provisional application is incorporated herein by reference.

### FIELD OF THE DISCLOSURE

The present disclosure generally relates to devices for dispensing one or more volatile actives. More particularly, the present disclosure relates to a direct current (DC) operated or chemical heat operated device for dispensing one or more volatile actives. The heat may be generated using a battery, a fuel cell, a solar cell, chemical heat or a combination thereof. More particularly, the present disclosure relates to an insect repellant device, which is easily portable and is capable of providing a sufficient vaporous stream of a volatile insecticide, and/or other active agent, to provide protection to a user. The device may also be configured to release other volatile active ingredients such as an antiseptic, a plant growth regulator, a herbicide, an air freshener, a deodorant, a medicament, a pheromone, or combinations thereof. By virtue of effective thermal management, the device is configured to operate at much higher efficiency than conventionally known in the art, such that a high percentage of the energy input into the device is converted to heat used to volatilize the insecticide or other active agent.

### BACKGROUND OF THE DISCLOSURE

Protection from nuisance insects, such as flies, no-see-ums and mosquitoes, in particular, is the major driving force behind the insect repellant business. A variety of devices that utilize active agents such as insect repellents (i.e., chemicals that repel insects away from a person as a way of removing the threat) and/or insecticides/pesticides (i.e., chemicals that kill insects as a way of removing the threat) exist in the marketplace today. These devices include both active-type devices and passive-type devices.

Active-type dispensers generally propel the active agent from a sealed container. The sealed container may include a pressurized gas, such as in the case of an aerosol can, or a manually or electrically driven pump. Generally, the active agent is in the form of a mist that is deposited on the skin or clothing to repel insects from the area to which the repellant is applied.

Unfortunately, the active-type dispensers have several disadvantages, including providing the active agent in a very high initial dosage. The active agent is generally dispensed at a very high rate, which creates an instantaneously heavy concentration of airborne active agent in the vicinity of the user. Some of the mist may be inhaled by the user and those nearby, and some of the rest will dissipate into non-active use. Additionally, safety and ecology can be issues with this type of dispenser as the handling of poisonous liquids can pose a threat to the user and to the environment and the discarding of used non-refillable cans can be a threat to the environment.

Passive-type dispensers have also been used and generally allow the active agent to volatilize from a ventilated container. The active agent may be present in the form of a liquid, gel or a solid, although typically an impregnated pad or granular form is utilized. The active agent is volatilized and released when exposed to the air directly or when the container is heated, such as with a propane or butane heat source, a candle, or an electrical heating element powered by AC power from a wall outlet.

The passive-type dispensers utilized to date have also suffered from several disadvantages. Without direct heating of the active material, the rate of vaporization of the active agent can be too slow to be effectively utilized in larger areas. However, using a flame, propane or butane torch, or candle for heating limits the use to a well-ventilated area due to the significant amount of heat generated. For many reasons, a torch or candle should not be used close to bodies or in wooded areas. Commercially available dispensers of this type possess little or no thermal management, which results in significant heat loss. Since much significant heat is wasted and not used to volatilize the active material, they require generation of a large amount of heat to be effective as they are generally very inefficient. From a consumer point of view, since batteries are generally more expensive to use than AC power, the key to the success of battery powered heating devices is to increase the efficiency of utilization of the battery's energy in order to make it run effectively as long as possible on one set of batteries. Therefore, the key to a compact, portable and cost-effective device is proper thermal management, such that a large fraction of the heat generated is utilized to vaporize the active ingredient, and minimize the losses usually associated with the devices known in the art.

As such, a need exists in the industry for insect repellant devices that are safe, environmentally friendly, efficient, and effective. It would be highly desirable to provide an insect repellant device that is safe, cost-effective, and portable, such as an insect repellant device powered by batteries, which can heat efficiently to produce a sufficient steam of a vaporous active agent to provide protection to the user. It would also be beneficial to provide an insect repellant device wherein the active agent can be easily replenished after depletion without the use of messy liquids.

### SUMMARY OF THE DISCLOSURE

Briefly, therefore, the present disclosure is directed to a device for dispensing a volatile active. The present disclosure is also directed toward a low power, high efficiency device for dispensing one or more volatile active ingredients. In one embodiment, there is disclosed a DC power operated device for dispensing a volatile active. The device is easily portable and is capable of providing a consistent stream of a vaporous volatile agent. The DC power may be obtained from a battery (primary or rechargeable), a fuel cell, a solar cell, or a combination thereof. In a specific embodiment, the device is a battery operated insect repellant device capable of dispensing a volatile insecticide. The device is configured to maximize efficiency such that heat generated by the heating element connected to the battery source is channeled directly to a substrate material including the insecticide and the amount of heat lost to the environment is significantly minimized.

The present disclosure is also directed to chemically powered devices for dispensing one or more volatile active. In one embodiment, there is disclosed a chemically powered insect repellant device that utilizes heat generated from an exothermic chemical reaction within the device to volatilize a volatile insecticide located within the device. These devices as described herein utilize a low wattage of heat to power the device as they are highly efficient.

As such, the present disclosure is directed to a DC power operated device for dispensing a volatile active. The device comprises a housing having an interior compartment, a substrate material including a volatile active and having opposite first and second faces and being disposed in the interior compartment, a first insulation material disposed in the interior compartment, and a first heating element disposed in the interior compartment intermediate the first insulating material and the first face of the substrate material.

The present disclosure is further directed to a battery operated device for dispensing a volatile active. The device comprises a housing including a movable carriage member, a first carrier member including a first heating element, a second carrier member including a second heating element, a first insulation piece sized and configured to fit in the first carrier member, and a second insulation piece sized and configured to fit in the second carrier member. The movable carriage member comprises a substrate material including a volatile active.

The present disclosure is further directed to a battery operated device for dispensing a volatile active. The device is capable of dispensing at least about 75 milligrams/hour of allethrin utilizing no more than about 5 watts of power.

The present disclosure is further directed to a battery operated device for dispensing a volatile active. The device is capable of dispensing at least about 25 milligrams/hour of metofluthrin utilizing no more than about 2 watts of power.

The present disclosure is further directed to a chemically powered device for dispensing a volatile active. The device being capable of dispensing at least about 75 milligrams/hour of allethrin utilizing no more than a bout 5 watts of heat power.

The present disclosure is also directed to a device that is a combination of a lighting device, such as a lantern, a flashlight or landscape lighting and a volatile material dispenser powered by a DC power source or a chemical power source or a combination thereof.

### BRIEF DESCRIPTION OF THE DRAWINGS

FIG. 1 shows an exploded view of a battery powered portable insect repellant device in accordance with one embodiment of the present disclosure.

FIG. 2 shows a battery powered portable insect repellant device in closed position in accordance with one embodiment of the present disclosure.

FIG. 3 shows a battery powered portable insect repellant device in open position in accordance with one embodiment of the present disclosure.

FIG. 4 shows a battery powered lantern including a battery powered insect repellant device attached thereto.

FIG. 5 shows an exploded view of a battery powered portable insect repellant device in accordance with one embodiment of the present disclosure.

FIG. 6 shows the substrate material facing side of a first carrier member in a housing supported by a rigid plastic frame for a battery powdered portable insect repellant device in accordance with a second embodiment of the present disclosure.

FIG. 7 shows a battery powered portable insect repellant device in closed position in accordance with a third embodiment of the present disclosure.

FIG. 8 shows a bottom view of a battery powered portable insect repellant device in closed position in accordance with the embodiment of FIG. 7.

Corresponding reference characters indicate corresponding parts throughout the several views of the drawings.

### DETAILED DESCRIPTION OF THE DISCLOSURE

The present disclosure relates to high efficiency portable devices, such as portable DC power operated devices, capable of dispensing a volatile agent. In one embodiment, the device is a battery operated device. The battery operated device, which can be a battery operated insect repellant device in one embodiment, or a battery operated flea or tick repellent device in another embodiment, is highly efficient and utilizes relatively low levels of energy generated by a battery to produce a vaporous stream of an insecticide or other volatile agent contained in a substrate material within the device. The device uses at least one resistance heating member that is near, or in some embodiments contact with, the substrate material to cause vaporization and release of the volatile active agent. Adequate thermal management within the device is a component of the present disclosure, which determines the efficiency of heat utilization. The thermal management is controlled through the use of insulating materials and through design of the device. The porosity of the ingredient carrying substrate, presence of other ingredients to control or accelerate the release of the volatile active, design of air flow channels, physical dimensions, surface area, shape, etc. can be modulated to deliver the desired heat generation rate and volatile active dispensing rate in a controlled manner. The heating and volatilization can therefore be made more efficient than current devices through the proper choice of insulating materials capable of withstanding the operating temperatures and through physical design.

As used herein, the term “insecticide” is meant to include both chemical compounds that kill nuisance pests such as mosquitoes, flies, no-see-ums, and the like, as well as chemical compounds that repel these types of bugs away from the compound. As such, the term “insecticide” is meant to include conventional insecticides, conventional pesticides, conventional insect repellant compounds, and combinations thereof.

Although described primarily herein in terms of battery operated devices for dispensing a volatile active, it should be understood that the present disclosure includes, and is directed to, devices for dispensing a volatile active that are powered by DC power sources in general as well as chemical energy provided by one or more exothermic chemical reactions occurring within in the device. In accordance with the present disclosure, chemical energy, such as heat energy, can be generated by chemical reactions within the device to power the device and drive the volatilization of the volatile active. A device in accordance with the present disclosure may be solely powered by exothermic chemical reactions, may be powered solely by one or more DC power sources (such as batteries, solar cells, fuel cells and the like) or may be powered by a combination of exothermic chemical reactions and one or more DC power sources.

The devices as described herein, whether powered by exothermic chemical means, DC power source means, or a combination of exothermic chemical means and DC power source means, can be sized and configured to be re-useable many times over, or can be sized and configured to be disposable after a single use. Also, the devices described herein can be sized and configured to dispense a volatile active to cover a large diameter, such as dispensing an insecticide over a diameter suitable to provide protection to an outside deck, a porch, a cabin or tent, or can be sized and configured to dispense a volatile active to cover a relatively small diameter, such as dispensing an insecticide over a diameter suitable to provide protection in the personal space around a single individual.

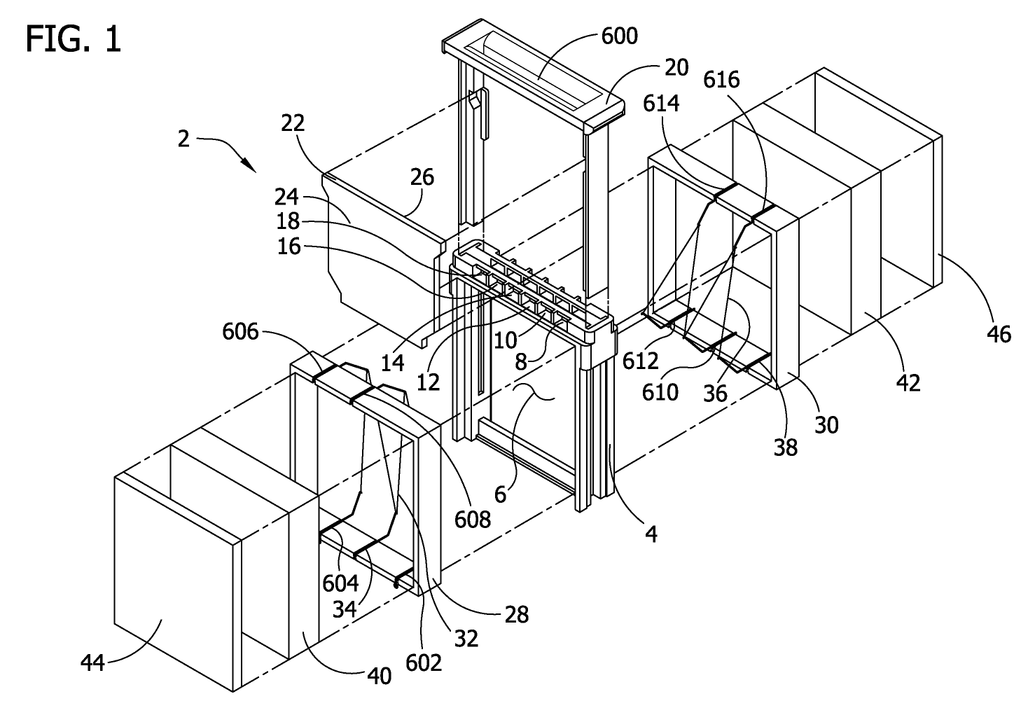

Referring now to FIG. 1, there is shown an exploded view of a battery operated device for dispensing a volatile active 2 in accordance with one embodiment of the present disclosure. The device 2 includes housing 4 having an interior compartment 6. Housing 4 has one or more air intake openings on the bottom thereof (not shown in FIG. 1), and has a number of “harmonica” type openings 8, 10, 12, 14, 16, and 18 on the top thereof to allow for volatilized active material to escape the housing.

Although generally less preferred, one, two, three, four, five, or even all six of the “harmonica” type openings could be omitted from the device. Housing 4 is sized and configured to slidably receive movable carriage member 20. A substrate material 22 including a volatile active thereon (not shown), has opposite faces 24 and 26 and is sized and configured for insertion into the movable carriage member 20 and/or the interior compartment 6. The movable carriage member 20 has a single vent opening 600. In an alternative embodiment, the moveable carriage member may have no vent openings or may have a plurality of vent openings. Although this embodiment is within the scope of the present disclosure, it is generally preferred that the moveable carriage member be constructed of one solid piece without any openings therein and the housing have a number of “harmonica” type openings as this configuration is less susceptible to rain or other moisture entering into the housing and contaminating the substrate material including the volatile active.

Housing 4 additionally comprises a first carrier member 28 and a second carrier member 30. First carrier member 28 includes a first resistance heating element 32, spring contact clips 34, 602, 604, 606, and 608 and first electrode wire (not shown) and second electrode wire (not shown) for connection to a battery source (not shown). Second carrier member 30 includes a second resistance heating element 36, spring contact clips 38, 610, 612, 614, and 616 and third electrode wire (not shown) and fourth electrode wire (not shown) for connection to a battery source (not shown). First carrier member 28 also includes first insulation piece 40 and second carrier member 30 also includes second insulation piece 42. First insulation piece 40 also includes a first film material (not shown) on the face directed toward the substrate material 22 and second insulation piece 42 also includes a second film material (not shown) on the face directed toward the substrate material 22. The housing 4 also includes first outer wall 44 and second outer wall 46. Although shown in FIG. 1 as including both a first resistance heating element 32 and a second resistance heating element 36, it will be understood by one skilled in the art that the device may have only one resistance heating element, which could either be the first resistance heating element or the second resistance heating element. Also, it will be understood by one skilled in the art that all or some of the first spring contact clips and second spring contact clips could be omitted from the device and the first resistance heating element and/or the second resistance heating element held on or near the substrate material by other components of the device. Where the spring contact clip is omitted, the resistance heating element can be held in place by an insulation piece and/or by an outer wall. It will be recognized by one skilled in the art that one or more of the spring contact clips may carry current to the heating member(s). Additionally, it will be understood by one skilled in the art that the contact clip could be any contact clip or equal part capable of holding the resistance heating element in place and need not be a spring-type clip. Furthermore, it should be understood by one skilled in the art based on the disclosure herein that the heating elements may be excluded from the device and heat may be provided within the device to drive off the volatile active from the substrate material via exothermic chemical reactions.

The housing is sized and configured for slidably receiving the movable carriage member that includes the substrate material including the volatile active. It will be readily contemplated by one skilled in the art that the movable carriage member could be omitted from the device and the substrate material including the volatile active could be inserted directly into the interior compartment of the housing through an opening therein. Alternatively, the substrate could be an integral part of a disposable carriage designed to minimize consumer contact with the substrate containing the volatile active. In this embodiment, the interior compartment of the housing is sized and configured for receiving a substrate material including the volatile active therein. Additionally, it will be readily contemplated by one skilled in the art that the first outer wall and second outer wall could be omitted from the device and that the first insulation piece and the second insulation piece could form the outer walls of the housing that enclose the interior compartment that contains the substrate material including the volatile active. Alternatively, the first insulation piece and/or the second insulation piece could be omitted from the device and the first outer wall and second outer wall could form the outer walls that enclose the interior compartment.

The housing is also sized and configured to allow the first carrier member and the second carrier member and the first outer wall and second outer wall to be mechanically attached thereto by a suitable means, such as for example, snapably received thereon, or secured via clips, magnets, screws, adhesives, or with other conventional means, such as uniform molding. It will be readily contemplated by one skilled in the art that the first carrier member and the second carrier member could be omitted and the resistance heating elements held in place near or against the substrate material including the volatile active by the first and second insulation pieces and/or by the first and second outer walls, depending upon the design of the device.

The top part of the housing onto which the movable carriage member slides down allowing the substrate material to be inserted into the housing generally defines an internal opening while the bottom of the housing may include a single opening therein to allow ambient air to enter the housing and carry the vaporized active agent out of the housing and movable carriage member. Alternatively, the bottom of the housing may include a plurality of openings therein to allow ambient air to enter the housing and carry the vaporized active agent out of the housing and movable carriage member.

The housing, movable carriage member, first and second carrier member, and first and second outer walls may be constructed from any material that is able to withstand the heat generated by the resistance heating mechanism internal to the housing without degrading or deforming. For example, the housing, movable carriage member, first and second carrier member, and first and second outer walls may be made of polyphenylene sulfide, high-temperature resistance nylons, and other suitable plastic materials. Furthermore, in one specific embodiment, it is desirable for the first and second carrier members to be supported by a rigid plastic frame made from a suitable plastic material such as polyphenylene sulfide. Although it is generally desirable that the housing, movable carriage member, first and second carrier member and first and second outer walls be formed from lightweight materials, the exact material utilized to form these pieces is not narrowly critical, so long as is it capable of withstanding the heat conditions and chemical exposure.

The movable carriage member is sized and configured for receiving the substrate material that includes the active agent. The movable carriage member may be sized and configured to snapably receive the substrate material, or may be sized and configured to allow the substrate material to be inserted and stabilized therein using other conventional means. The movable carriage member is also sized and configured so that it can slide into the housing unit once the substrate material is inserted into the movable carriage member. It will be readily contemplated by one skilled in the art based on the disclosure herein that the housing could be designed to allow the movable carriage member to be inserted therein through means other than sliding; that is, the housing could be designed to allow the movable carriage member to be snapped into the housing or introduced with other conventional means.

The movable carriage member may have a single vent opening on the top surface thereof above the substrate material to allow for the escape of the vaporous material formed upon the energizing of the device. Alternatively, the movable carriage member may have a plurality of vent openings on the top surface thereof to allow for the escape of the vaporous material formed upon the energizing of the device. The number and size of the vent openings is not narrowly critical and may vary upon the desired design so long as the efficiency of the device is not substantially compromised.

The substrate material that includes the insecticide or other active agent as described below may be comprised of any material that is capable of holding an active agent thereon or therein and is capable of withstanding the temperatures produced by the heating element or elements. The substrate may comprise fibrous woven or non-woven material or powders or flakes as well as a combination thereof. Generally, the substrate material should be capable of not substantially degrading or deforming at temperatures of up to about 230° C., although this depends upon the operating temperature of the device, which is dictated by the properties of the volatile active. The overall size of the substrate material may vary depending upon the desired end application, and is not narrowly critical so long as it is sized and configured to fit into the movable carriage. Generally, the substrate material will have a thickness of from about 0.1 millimeters to about 10 millimeters. Heat conducting additives such as carbons, metal particles or fibers may be incorporated to assist and regulate the transfer of heat to the interior of the substrate material. Additionally, the porosity and the pore size distribution within the substrate can be designed to control the release rate of the volatile active.

The substrate material is impregnated with the insecticide or other active agent in an amount such that upon heating, the insecticide or active agent can be volatilized off of the substrate for the desired sustained period to deliver the desired sustained amount. In addition to the insecticide or other active agent, the substrate material may also be impregnated with a volatilization control agent to control the volatilization of the insecticide or other active ingredient. Synergistic agents may also be incorporated to accelerate or promote the volatilization rate. Suitable volatilization control agents may include, for example, piperonyl butoxide, 2,5-di-t-butylhydroquinone; 3,5-di-t-butyl-4-hydroxytoluene; 3-t-butyl-4-hydroxyanisole, and combinations thereof. In one specific example, the substrate material may have an area of 1000 mm² to 2500 mm² and contain 250 milligrams to 600 milligrams of pesticide, such as d-allethrin, 600 milligrams to 1000 milligrams of piperonyl butoxide, and 100 milligrams of 2,5-di-t-butylhydroquinone for outdoor applications. It should be noted that the release rate and the total released amount in a given time interval depend upon the application environment. For indoor use, for example, the d-allethrin loading in the substrate material can be as low as 40 milligrams in the above example. Any number of suitable substrate materials containing an insecticide are commercially available companies such as Zobele (Trento, Italy).

The substrate material is impregnated with an insecticide and/or other volatile active such that the insecticide and/or other volatile active is volatilized off of the substrate material during heating of the resistance heating member(s). Any number of suitable insecticides can be incorporated on or in the substrate material including, for example, pyrethrins, chrysanthemic acid derivatives, pyrethroids, and mixtures thereof. Specifically, the insecticide may be selected from the group consisting of allethrin, d-allethrin, bioallethrin, S-bioallethrin, empenthrin, prallethrin, transfluthrin, and combinations thereof. In one specific embodiment, the pesticide is 3-allyl-2-methylcyclopenta-2-ene-4-one, and/or, N,N-diethyl meta-toluamide, and/or metafluthrin. Other suitable volatile actives include, for example, an antiseptic, a fungicide, a plant growth regulator, a herbicide, an air freshener, a perfume, a deodorant, a medicament, a pheromone, and combinations thereof.

The first resistive heating element is located intermediate the first insulating material (or first outer wall if the first insulating material is not utilized) and the first face of the substrate material including a volatile active and the second resistive heating element is located intermediate the second insulating material (or second outer wall if the second insulating material is not utilized) and the second face of the substrate material including a volatile active. Although it is generally preferred that the resistive heating element be in direct contact with the substrate material including the volatile active, the resistive heating element may be located in close proximately to the substrate material such that the resistive heating element can appropriately heat the substrate material to volatilize the active material. The resistive heating elements can be any resistance heating elements known in the art including, for example, wires, thin films and thick films. One preferred resistive heating element for use in the devices described herein is a Nickel-chromium wire. Another preferred resistive heating element for use in the device described herein is a thin film tin oxide.

The heating element(s) is generally heated to a temperature sufficient to heat the substrate material including the volatile active to a temperature sufficient to provide for a consistent, stable release of the volatile active. For dispensing allethrin, generally the heating element is heated to provide a temperature on the surface of the substrate material of from about 130° C. to about 200° C., typically from about 140° C. to about 180° C., although with some insecticides and other volatile actives the desired temperatures may be lower depending on the partial pressures of the desired volatile active.

Thermal management to increase the efficiency of energy use is one advantage of the present disclosure. The first insulating material and the second insulating material are present in the device described herein to increase the efficiency of the device; that is, the insulation materials are present to allow the device to more efficiently utilize the heat generated by the heating element powered by the battery power supply. Any type of insulation capable of not degrading at the operational temperature of the heating device is suitable for use in the devices described herein.

For example, in one embodiment, the first insulating material and the second insulating material are thermal insulating materials. Thermal insulating materials refer generally to materials used to reduce the rate of heat transfer therebetween. As known in the art, heat can be transferred from one material to another by conduction, convection, and/or radiation. Suitable thermal insulating materials can include, for example, reflectors, foams, films, and fibrous materials.

In another embodiment, the first insulating material and the second insulating material are electrical insulating materials. Electrical insulating materials typically contain no free electrons and, as such, prohibit the flow of electricity. Suitable electrical insulating materials can include rubber-like polymers and many plastics.

In one particularly preferred embodiment, the first insulating material and the second insulating material are both thermal and electrical insulating materials.

Particularly suitable insulation materials in the order of temperature resistance are polyurethane foam, polyisocyanurate foam, melamine foam, and poly imide foam. In one embodiment, the first insulating piece and/or the second insulating piece may include on the face facing the substrate material including the volatile active a film material to inhibit the migration and transfer of the volatile active from the substrate material into the insulation. One suitable film includes a poly imide material such as a kapton film.

The battery operated devices described herein can be powered using a number of different sized batteries including, for example, 9-volt, AA, AAA, C, D and lantern-size batteries. As would be contemplated by one skilled in the art based on the disclosure herein, multiple batteries of the same size can be utilized simultaneously to power the device. Additionally, it would be understood by one skilled in the art that the battery operated devices as described herein could be integrated into one or more other products to produce a product capable of performing a number of functions. For example, the battery operated insect repellant device as described in one embodiment herein could be integrated with a battery operated lantern to produce a single unit capable of providing light and repelling insects. In one embodiment, a single set of batteries could power both the lantern and the insect repellant device. In another embodiment, the battery operated insect repellant device could be integrated with a battery operated flashlight to produce a single unit capable of providing light and repelling insects. Similarly, a solar powered or a combination rechargeable battery-solar powered landscape light and volatile active dispenser can be combined in one unit to serve multiple purposes.

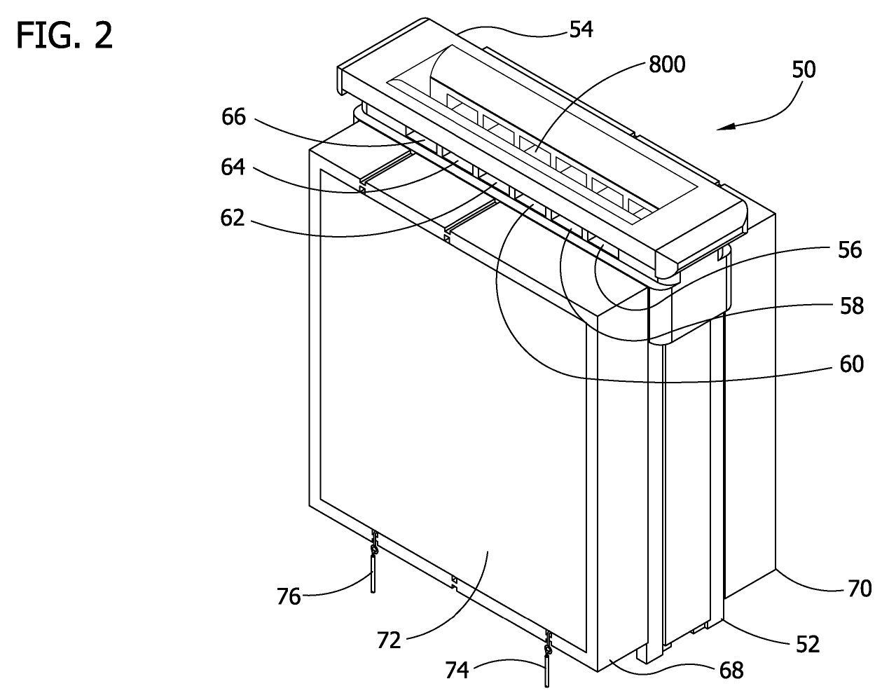

Now referring to FIG. 2, there is shown a battery operated device in accordance with one embodiment of the present disclosure in closed position; that is, in position where the movable carriage member is closed into the housing. The device 50 includes housing 52 including moveable carriage member 54 having vent opening 800. The housing includes a plurality of openings 56, 58, 60, 62, 64, and 66 for allowing a volatilized active to escape therefrom. The device also includes first carrier member 68 and second carrier member 70. First carrier member 68 includes first insulation piece 72 and first electrode wire 74 and second electrode wire 76.

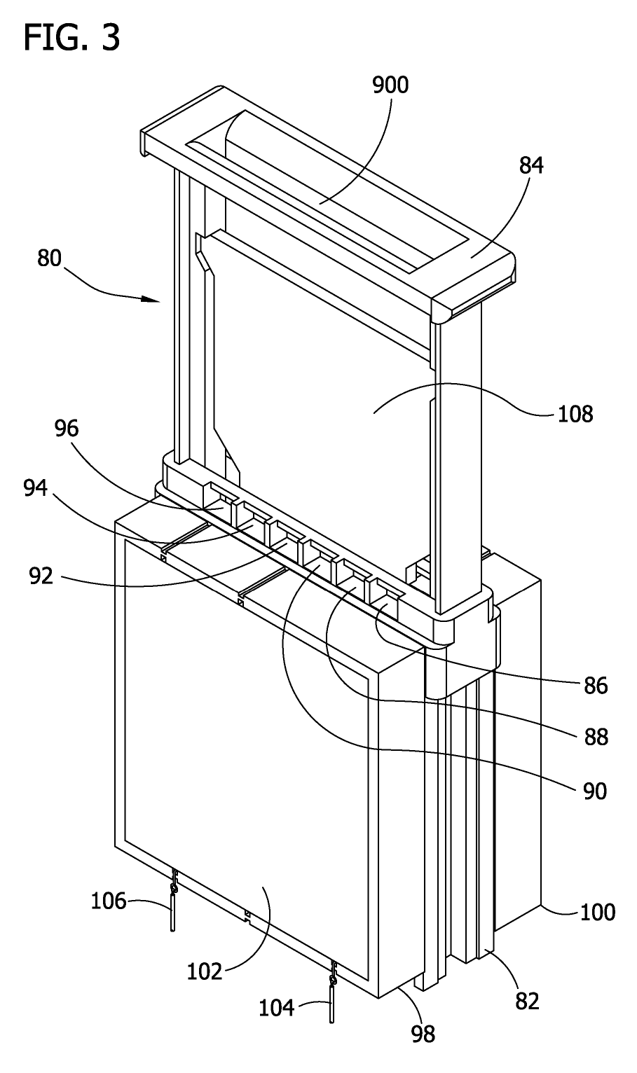

Now referring to FIG. 3, there is shown a battery operated device in accordance with one embodiment of the present disclosure in open position; that is, in position where the movable carriage member is extended away from the housing and capable of receiving a substrate material including a volatile active. The device 80 includes housing 82 including moveable carriage member 84 having vent opening 900. The housing also includes a plurality of openings 86, 88, 90, 92, 94, and 96 for allowing a volatilized active to escape therefrom. The device also includes a first carrier member 98 and a second carrier member 100. First carrier member 98 includes first insulation piece 102 and first electrode wire 104 and second electrode wire 106. The moveable carriage member 84 includes substrate material 108.

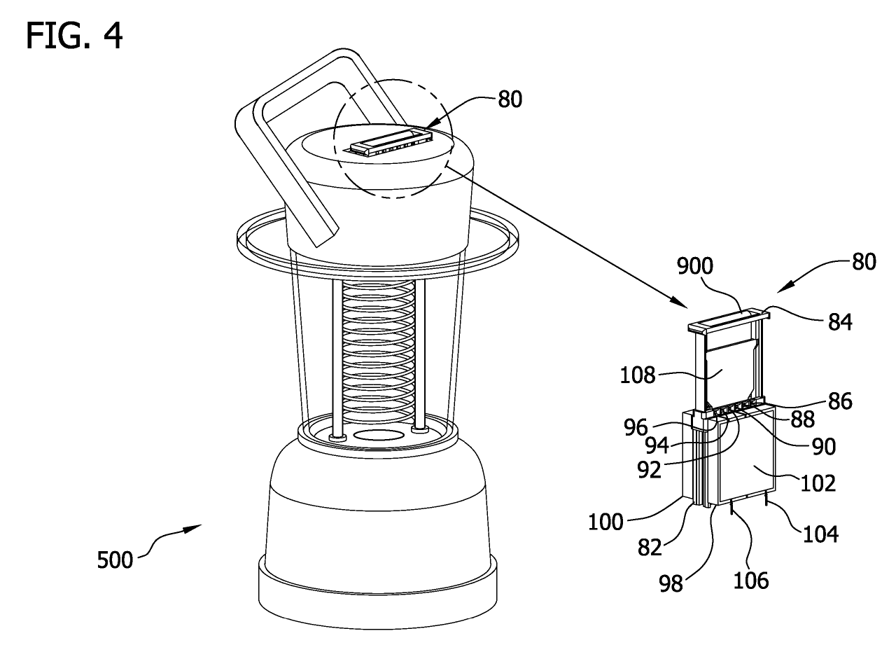

Now referring to FIG. 4, there is shown a battery operated lantern 500 including a battery operated insect repellant device 80 attached thereto. The battery operated insect repellant device can be molded directly into the lantern, or can be attached thereto by any means available in the art such as, for example, hook and loop fasteners, snapably attached, adhesives, and the like. The lantern including the battery operated insect repellant device can be configured such that both the lantern and the insect repellant device are powered by the same battery source such as, for example, D size batteries. Alternatively, the lantern can be powered by one battery source and the insect repellant device powered by another, separate, battery source, or by chemical means.

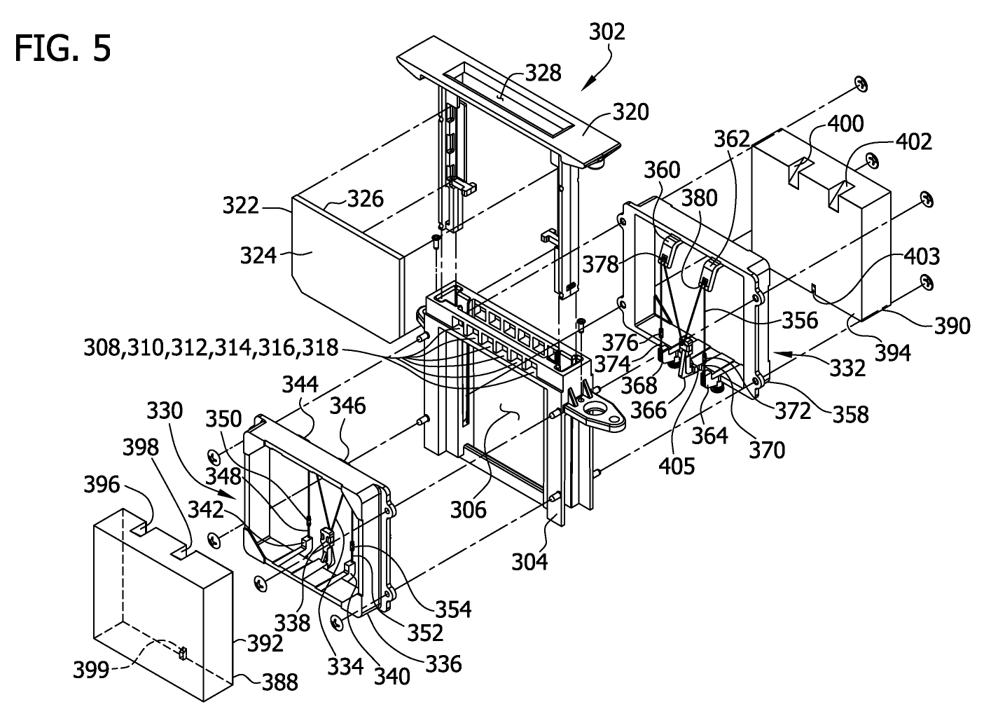

Now referring to FIG. 5, there is shown a battery operated device in accordance with an alternative embodiment of the present disclosure. Specifically, in this embodiment, the device 302 includes housing 304 including moveable carriage member 320 having a single vent opening 328. The housing includes a number of “harmonica” type openings 308, 310, 312, 314, 316, and 318 for allowing a volatilized active to escape therefrom. Housing 304 is sized and configured to slidably receive movable carriage member 320. A substrate material 322 including a volatile active thereon (not shown), has opposite faces 324 and 326 and is sized and configured for insertion into the movable carriage member 320.

Housing 304 additionally comprises a first carrier member 330 and a second carrier member 332. First carrier member 330 is supported by rigid plastic frame 336, and second carrier member 332 is supported by rigid plastic frame 358. The rigid plastic frame may be comprised of any suitable rigid polymeric material known in the art. One particularly preferred rigid polymeric material is polyphenylene sulfide. First carrier member 330 includes a first resistance heating element or wire 334 being permanently affixed to frame 336 by rigid clips 338, 340, 342, 344, and 346. The first resistance heating element 334 is also attached to a first electrode wire 348 by a crimp wire 350 and a second electrode wire 352 by a crimp wire 354, for connection to a battery source (not shown). The second carrier member 332 similarly includes a second resistance heating element 356 being permanently affixed to frame 358 by rigid clips 360, 362, 364, 366, and 368. Although shown in FIG. 5 as including both a first resistance heating element 334 and a second resistance heating element 356, it will be understood by one skilled in the art that a device may have only one resistance heating element or wire, which could either be the first resistance heating element or wire or the second resistance heating element or wire.

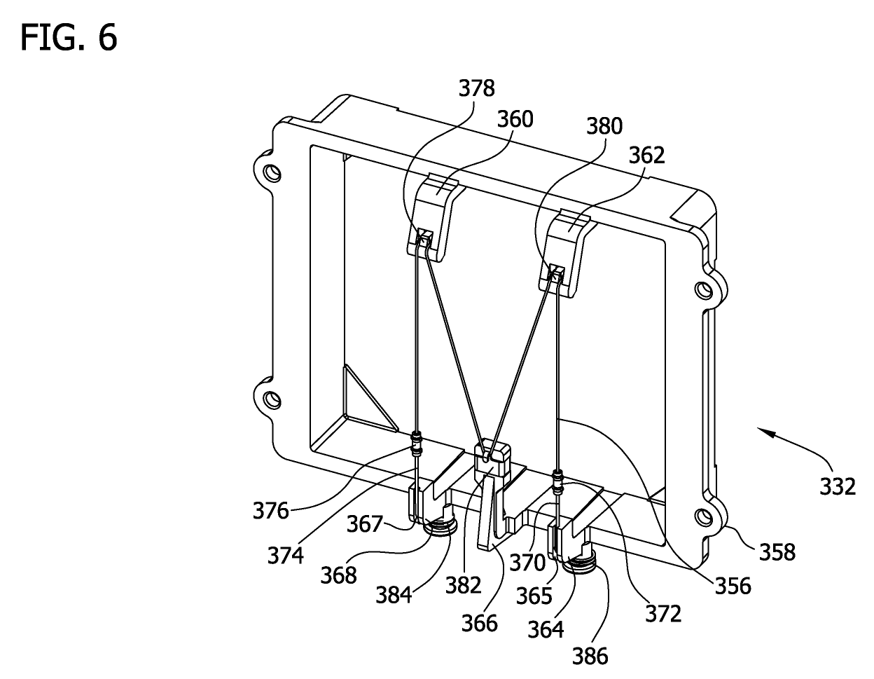

The second resistance heating element or wire 356 is also attached to a third electrode wire 370 by a crimp wire 372 and a fourth electrode wire 374 by a crimp wire 376, for connection to a battery source (not shown). As further illustrated in FIG. 6, in one embodiment, the rigid clips are integral with their respective rigid plastic frames; that is, each rigid plastic frame and set of clips are part, of a single, molded piece of a rigid polymeric material, for example, polyphenylene sulfide.

Referring to FIG. 6, the second resistance heating element 356 is in the shape of an “M” (when in the upright position), the upper points being woven around posts 378 and 380 formed by notched cutouts or channels in rigid clips 360 and 362, respectively. Although shown in FIG. 6 as the second resistance heating element 356 in the second carrier member 332, it will be understood by one skilled in the art that the first resistance heating element in the first carrier member may be in the same configuration in addition to or as a substitute for the second heating element in the second carrier member. The center point of the second resistance heating element 356 is attached to rigid clip 366 by means of a strap 382, which can be a metal or plastic strap, which surrounds the rigid clip. Although only the strap 382 surrounding rigid clip 366 is shown in FIG. 6, one skilled in the art would understand that the middle rigid clip of first carrier member may also be surrounded by a strap. Finally, as shown in FIGS. 5 and 6, each end of the second heating element 356 is attached to separate rigid clips (i.e., clips 364 and 368 for element 356; clips 340 and 342 for element 336 in the first carrier member 330) by the crimp wires 372 and 376 and electrode wires 370 and 374 respectively, the latter of which extend through grooves or channels 365 and 367 in the rigid clips 364 and 368, respectively, and wrap around posts 386 and 384, which are also an integral part of rigid plastic frame 358.

Notably, although the heating elements are attached to or supported by the rigid plastic frames of the first and second carrier members, these elements (i.e., wires) are not under tension; that is, these wires are generally not attached to the frames in such a way that results in stretching of the wires between the points of attachment. Furthermore, the rigid clips, and rigid plastic frames of which they are a part, generally do not exert any forward or backward directional force on the heating elements or wires; that is, the clips and frames do not force the heating elements or wires toward, or away from, the surface of the substrate material. Rather, the clips and frames are designed simply to hold the heating elements or wires in a plane generally parallel to the surface of the substrate material.

Furthermore, as shown in FIG. 5, the first carrier member 330 also includes a first insulation piece 388, and the second carrier member 332 also includes a second insulation piece 390. The first insulation piece 388 includes a first film material 392 on the face directed toward face 324 of the substrate material 322 and the first resistance heating element 334, while the second insulation piece 390 also includes a second film material 394 on the face directed toward the opposite face 326 of the substrate material 322 and the second resistance heating element 356. The first and second insulation pieces are typically prepared from a foam material. Typically, the film is made of a material such as a Kapton® film to inhibit migration and transfer of the volatile active from the substrate material into the insulating foam. Suitable foams for use in the insulation pieces include, for example, foams such as a polyurethane foam, a polyisocyanurate foam, a melamine foam, or a poly imide foam. As further illustrated by FIG. 5, the first insulation piece 388 also includes two grooves or notched channels, 396 and 398, located at the top of the piece (when viewed in the upright position) on the side facing the substrate material, which are appropriately sized such that at least a portion of rigid clips 344 and 346, respectively, fit into or are recessed therein. Similarly, the second insulation piece 390 also includes two grooves or notched channels, 400 and 402, located at the top of the piece (when viewed in the upright position) on the side facing the substrate, which are appropriately sized such that at least a portion of rigid clips 360 and 362, respectively, fit into or are recessed therein. Furthermore, a third groove or notched channel 403 can be located on the bottom of the second insulation piece 390 on the side facing the substrate, which is appropriately sized such that at least a portion 405 of rigid clip 366 fits into or is recessed therein. The thickness of insulation pieces 388 and 390 is approximately equal to the thickness of rigid plastic frames 336 and 358, respectively. Accordingly, these insulation pieces are designed to be positioned near to or against the heating elements or wires, but are not designed to force the heating elements or wires toward the surface of the substrate material. Additionally, the first and second insulation pieces of FIG. 5 serve as the outer walls of the housing 304. Although shown as the outer walls in FIG. 5, outer walls, in addition to the insulation pieces, can be included in the device.

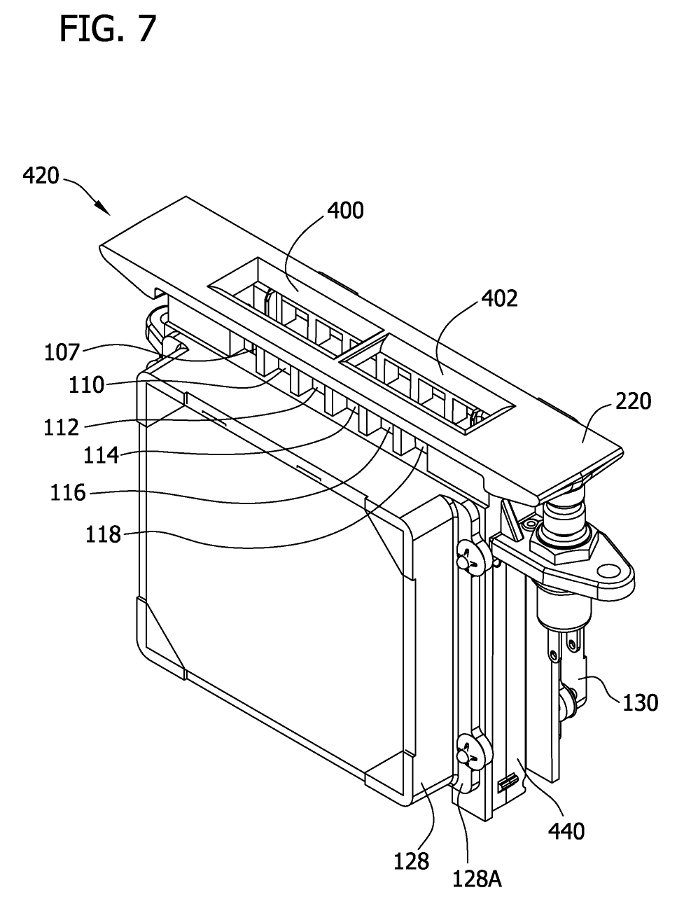

Now referring to FIG. 7, there is shown a battery operated device in accordance with one embodiment of the present disclosure in closed position; that is, in position where the movable carriage member is closed into the housing. The device 420 includes housing 440 including moveable carriage member 220 having two vent openings 400 and 402. The housing includes a plurality of harmonica-type openings 107, 110, 112, 114, 116, and 118 for allowing a volatilized active to escape therefrom. The device also includes first carrier member 128 and second carrier member 130. First carrier member 128 is supported by rigid plastic frame 128A.

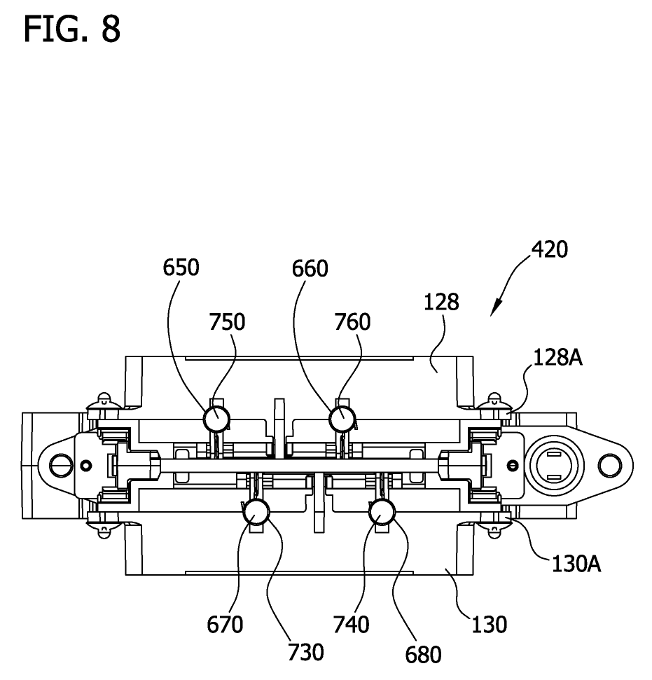

Now referring to FIG. 8, there is shown the bottom view of a battery operated device in accordance with the embodiment of FIG. 7 of the present disclosure in closed position. The device 420 includes a first carrier member 128 and a second carrier member 130. First carrier member 128 is supported by rigid plastic frame 128A and includes first electrode wire 650 and second electrode wire 660, which are wrapped around posts 750 and 760, respectively. Second carrier member 130 is supported by rigid plastic frame 130A and includes third electrode wire 670 and fourth electrode wire 680, which are wrapped around posts 730 and 740, respectively.

Upon activation of the battery operated device for dispensing a volatile active, the resistance heating element, such as a Nickel-chromium wire, is energized and begins to heat up in the interior compartment of the housing. Because the heating element is very near, or even touching, the substrate material including the volatile active in the interior compartment, the heat is transferred from the heating element to the substrate material causing the volatile active to be volatilized off of the substrate material and out of the device. There are at least two unique features that differentiate the device described herein from conventional volatile passive dispensing devices. The first feature is that the heating source is generally only a few lines of the resistive heating wire over the substrate material surface. Therefore, the heat loss is minimized as the heating is highly localized. Surprisingly, it has been found that when the Nickel-chromium wire is in contact with the substrate material including the volatile active, such as a pesticide like d-allethrin, the d-allethrin actually wicks toward the heat source such that the majority of the d-allethrin can be volatilized out of the substrate material over time at a fairly constant rate. The second feature is thermal management utilizing insulation pieces. Because the battery operated device generally includes one or more insulation pieces in close proximity to the heating element and substrate material including the volatile active, the device operates at high efficiency; that is, the device utilizes a relatively low amount of energy to volatilize the active material.

One particular advantage of the devices described herein for dispensing a volatile active is that they can dispense an effective amount of a volatile active, such as an insecticide, utilizing small amounts of power; that is, the device can dispense a continuous amount of an insecticide suitable to repel and/or kill nuisance insects while only consuming a small amount of wattage. This results from the fact that the efficiency of energy utilization is significantly higher than the efficiency of energy utilization in commercially available or otherwise known conventional art. Due to inadequate thermal management resulting in very significant heat losses, butane heated or alternating current (AC) heated devices known in the art are extremely inefficient and generally have to produce much more heat than is necessary for volatilizing active ingredients. This results in a device that gets too hot to be portable or usable indoors, or too big or cost-inefficient. Although the use of batteries has been proposed by others for dispensing volatile actives, the absence of proper thermal management and the resulting high inefficiency results in much of the battery power in those approaches being wasted. Such devices are therefore not practical or cost effective to a consumer. To overcome these limitations of the prior art, the present disclosure enables efficient energy utilization by proper thermal management. Due to a much higher energy utilization efficiency, the DC power sources (e.g. batteries, fuel cells, solar cells, and the like) utilized for this disclosure will last substantially longer (e.g. 3× to 4× longer) as compared to when the same batteries are used in conventional volatile active dispensing devices. The high efficiency of the devices described herein also allows for the devices to be smaller, easily portable and safely utilized.

The high energy efficiency of the device described herein is demonstrated in the following examples:

### EXAMPLE 1

A commercial device A, Thermacell (by The Schawbel Corporation, Bedford, Mass.), is a heating device using a 0.42 oz (11.9 g) butane cartridge claimed to be designed for 12 hrs of heating. From the theoretical butane heat content of 49300 joule/g (available in standard tables), the device heating power is calculated to be 13.6 W. The geometric surface area of the ThermaCell Mosquito Repellent mat (21.97% of d-cis/trans allethrin) was about 32 cm², and the d-cis/trans allethrin release was experimentally determined by measuring the mat weight loss during the 2^{nd} hour* of heating under two separate conditions. In one condition in ambient atmosphere in a laboratory hood with the exhaust turned off, the evaporation rate was determined to be about 60 mg/hr. In a second experimental condition where the only difference was that the laboratory hood exhaust was switched on, the allethrin evaporation rate was determined to be 100 mg/hr. The presence of a draft of air increased the release rate of allethrin.
*It has been found that the mat weight loss measured in the 2^{nd} hour of heating correlates better with the allethrin vaporization release since much of the inert organic carrier materials in the mat also evaporate during the 1^{st} hour of heating and confound the measurements.

### EXAMPLE 2

A device B was assembled by using a metal plate with a resistive heating wire attached to heat a Mosquito Repellent mat, containing 21.97% of d-cis/trans allethrin with 16 cm² geometric surface area. One side of the mat was exposed to ambient room temperature conditions while the other side of the mat was directly placed on the metal plate having the same geometric surface area as the mat. An insulating foam block (poly-isocyanurate) was placed against the back surface of the metal plate (the side that was not used to heat the mat) to minimize the heat loss. The device was placed in the same laboratory hood as above, but with the exhaust turned off. Upon constant power heating of the device B using a controlled DC power source, an Allethrin evaporation rate of 47 mg/hr was measured for 3.06 W of constant power input.

### EXAMPLE 3

A device C as shown in FIG. 1 was assembled to heat a Mosquito repellent mat, containing 21.97% of d-cis/trans allethrin and having 25 cm² geometric surface area. The pad in this case was heated using nichrome wires as described elsewhere herein. The device also contained sufficient insulation using melamine foam insulation on both sides of the substrate material to improve thermal management and reduce heat loss. The device was placed in the same laboratory hood with the exhaust turned off. In this experiment, Allethrin evaporation rate of 75 mg/hr was measured upon application of 2.45 W of constant power heat input using the same power source as in example 2 above.

Energy Efficiency:

The energy efficiency of a device in mg released per hour per watt of energy input can be calculated based on the heat generated and the weight loss from the substrate (mat in the examples above). The efficiency of various devices can thereby be quantitatively compared.

Another approach is to also incorporate the area of the substrate being heated, to compare devices of different substrate geometric area, since the release rate is a strong function of the surface area.

Hence two parameters X & Y can be determined. X represents mg/hr watt and Y represents the surface area normalized parameter in mg/hr watt cm². The higher the X & Y values, the more energy efficient the device is.

| | A1 | A2 | B | C |
|---|---|---|---|---|
| | (hood | (hood | (hood | (hood |
| | Exhaust | Exhaust | Exhaust | Exhaust |
| Device | on) | off) | off) | off) |
| X, mg/hr | 7.4 | 4.4 | 15.4 | 30.6 |
| watt | | | | |
| Y, mg/hr | 0.2056 | 0.1375 | 0.9625 | 1.224 |
| watt cm² | | | | |

It is evident from Table 1, that the devices B and C with improved thermal management can achieve significantly higher efficiencies ranging from about 3× to about 7× the efficiency of a commercially available device to dispense the same volatile active.

The energy efficiency can be also compared on the basis of vaporization efficiency, η, which can be calculated as follows, using the heat of vaporization (which can be obtained from manufacturer of the active compound) of the insecticide material within the operating temperature range of the device.
η=ΔH*A/P=ΔH*X/3600000 [1]

ΔH=is the heat of vaporization in J/g

A=the release rate in mg/h

P=the heat energy input, watt

X=Release rate/watt, mg/hr/watt

Accurate values of heat of vaporization of the particular insecticide should be available from the supplier or can be measured and calculated following the standard method described in ASTM E2071.

The results from Examples A, B and C can be converted to efficiency using equation 1 above, and as shown in Table 2 below:

| | A1 | | | |
|---|---|---|---|---|
| | (exhaust | | | |
| Device | on) | A2 | B | C |
| % using ΔH = | 0.046% | 0.027% | 0.096% | 0.19% |
| 224 J/g (heat of | | | | |
| vaporization | | | | |
| of bio-allethrin) | | | | |

In accordance with the present disclosure, there is disclosed a device where the area normalized release rate of allethrin (Y) is greater than about 0.15 mg/hr-watt-cm², or greater than about 0.2, or greater than about 0.4 or greater than about 0.5 mg-hr-watt-cm² when tested in a device (of Example 3) of the present disclosure in ambient air environment (about 25° C.).

In accordance with the present disclosure, there is disclosed a device where the Energy Efficiency of bio-allethrin release is (as discussed in Table 2) greater than about 0.03%, or greater than about 0.05% or greater than about 0.06% or greater than about 0.09% or greater than about 0.1% when calculated using Delta H=224 J/g and when tested in the device (of Example 3) in a ambient air environment (about 25° C.).

One skilled in the art will appreciate that a similar calculation can be performed for other active volatile materials which may have lower or higher heats of vaporization.

In one embodiment where allethrin or a related compound is used as the insecticide, at least about 10 mg/hour, desirably at least about 50 mg/hour, and still more desirably at least about 75 mg/hour is dispensed from the device to provide the desired repelling/killing of the insects. In another embodiment where metofluthrin or a related compound is used as the insecticide, at least about 0.1 mg/hour, desirably at least about 5 mg/hour, and still more desirably at least about 25 mg/hour is dispensed from the device to provide the desired repelling/killing of the insects.

In accordance with the present disclosure and as noted above, chemistries involving chemical reactions that generate heat (i.e., exothermic chemical reactions) may also be utilized within the device to power the device and drive the volatilization of the volatile active out of the device. The exothermic chemistries may be utilized solely to power the volatile agent dispensing device (that is, without any batteries or other power supply), or they may be used in combination with one or more batteries to power the device. The generated heat from the chemical reaction can be directed toward the substrate material including the volatile active to heat the substrate material and drive off the volatile active. Utilizing exothermic chemical reactions to power the volatile agent dispensing device allows for the device to be easily manufactured as a single-use device that may be disposable after the single use.

1. A DC power operated device for dispensing a volatile active, the device comprising:
a housing having an interior compartment;
a substrate material including a volatile active, the substrate material having opposite first and second faces and being disposed in the interior compartment;
a first insulation material disposed in the interior compartment; and
a first heating element disposed in the interior compartment intermediate the first insulating material and the first face of the substrate material.

2. The DC power operated device as set forth in claim 1 further comprising a second insulation material disposed in the interior compartment and a second heating element disposed in the interior compartment intermediate the second insulating material and the second face of the substrate material including the volatile active.

3. The DC power operated device as set forth in claim 2 wherein both of the first insulation material and the second insulation material comprise thermal insulating materials.

4. The DC power operated device as set forth in claim 3 wherein the first insulation material and second insulation material both include a film material on at least one surface thereof.

5. The DC power operated device as set forth in claim 2 further comprising a spring contact clip for holding the first heating element against the substrate material including a volatile active.

6. The DC power operated device as set forth in claim 5 further comprising a spring contact clip for holding the second heating element against the substrate material including a volatile active.

7. The DC power operated device as set forth in claim 2 wherein the housing includes a single opening on the bottom thereof to allow for ambient air to enter the housing.

8. The DC power operated device as set forth in claim 2 wherein the housing includes a plurality of openings on the bottom thereof to allow for ambient air to enter the housing.

9. The DC power operated device as set forth in claim 1 wherein the volatile active is an insecticide or repellant.

10. The DC power operated device as set forth in claim 1 wherein the volatile active is selected from the group consisting of an antiseptic, a fungicide, a plant growth regulator, a herbicide, an air freshener, a perfume, a deodorant, a medicament, a pheromone, and combinations thereof.

11. A battery operated device for dispensing a volatile active, the apparatus comprising:
a housing including a movable carriage member, the movable carriage member comprising a substrate material including a volatile active;
a first carrier member including a first heating element;
a second carrier member including a second heating element;
a first insulation piece sized and configured to fit in the first carrier member; and
a second insulation piece sized and configured to fit in the second carrier member.

12. The battery operated device as set forth in claim 11 wherein the first carrier member and the second carrier member both include one or more rigid clips integral therewith for supporting the first heating element and the second heating element.

13. The battery operated device as set forth in claim 12 wherein both the first insulation piece and the second insulation piece include one or more notched channels therein for receiving the one or more rigid clips therein.

14. The battery operated device as set forth in claim 13 wherein both the first insulation piece and the second insulation piece comprise thermal insulating materials.

15. The battery operated device as set forth in claim 14 wherein the first insulation piece and second insulation piece each additionally comprise a film material on at least one surface thereof.

16. The battery operated device as set forth in claim 11 wherein the first heating element and the second heating element include electro-resistive heating elements.

17. The battery operated device as set forth in claim 14 wherein the housing includes a single opening on the bottom thereof to allow for ambient air to enter the housing.

18. The battery operated device as set forth in claim 14 wherein the housing includes a plurality of openings on the bottom thereof to allow for ambient air to enter the housing.

19. The battery operated device as set forth in claim 14 wherein the movable carriage member includes one or more openings on the top thereof to allow for vapor to pass therethrough.

20. The battery operated device as set forth in claim 11 wherein the volatile active is selected from the group consisting of an antiseptic, a fungicide, a plant growth regulator, a herbicide, an air freshener, a perfume, a deodorant, a medicament, a pheromone, and combinations thereof.

21. A battery operated device for dispensing a volatile active, the device being capable of dispensing at least about 25 milligrams/hour of volatile active utilizing not more than about 5 watts of power.

22. The battery operated device as set forth in claim 21 wherein the volatile active is allethrin, and wherein the device is capable of dispensing at least about 75 milligrams/hour of allethrin utilizing no more than about 5 watts of power.

23. The battery operated device as set forth in claim 22 wherein the device comprises a housing having an interior compartment, a substrate material including a volatile active, the substrate material having opposite first and second faces and being disposed in the interior compartment, a first insulation material and a second insulation material disposed in the interior compartment, a first heating element disposed in the interior compartment intermediate the first insulating material and the first face of the substrate material, and a second heating element disposed in the interior compartment intermediate the second insulating material and the second face of the substrate material.

24. The battery operated device as set forth in claim 21, wherein the volatile active is metofluthrin, and the device being capable of dispensing at least about 25 milligrams/hour of metofluthrin utilizing no more than about 2 watts of power.

25. The battery operated device as set forth in claim 24 wherein the device comprises a housing having an interior compartment, a substrate material including a volatile active, the substrate material having opposite first and second faces and being disposed in the interior compartment, a first insulation material and a second insulation material disposed in the interior compartment, a first heating element disposed in the interior compartment intermediate the first insulating material and the first face of the substrate material, and a second heating element disposed in the interior compartment intermediate the second insulating material and the second face of the substrate material.

26. (canceled)
